(19) United States
(12) Patent Application Publication
(10) Pub. No.: US 2023/0397635 A1
(43) Pub. Date: Dec. 14, 2023

(54) IMPROVED FEED INGREDIENT FROM DRIED DISTILLERS GRAINS USING DRY TRIBO-ELECTROSTATIC SEPARATION

(71) Applicant: SEPARATION TECHNOLOGIES LLC, Needham, MA (US)

(72) Inventors: Natsuki Barber, Medway, MA (US); Kyle P. Flynn, Moseley, VA (US); Abhishek Gupta, Cambridge, MA (US)

(21) Appl. No.: 18/035,434

(22) PCT Filed: Nov. 5, 2021
(86) PCT No.: PCT/US2021/058304

§ 371 Date: May 4, 2023

Related U.S. Application Data
(60) Provisional application No. 63/110,640, filed on Nov. 6, 2020.

(51) Int. Cl. A23K 10/38; A23K 50/80; A23K 10/22; A23K 20/142; A23K 20/26

(52) U.S. Cl. CPC A23K 10/38; A23K 50/80; A23K 10/22; A23K 20/142; A23K 20/26

(57) ABSTRACT

An improved ingredient for animal feed produced from distillers grains using a tribo-electro static belt separation process is disclosed.

### CROSS-REFERENCE TO RELATED APPLICATION

This application claims the benefit of priority under 35 U.S.C. § 119 to U.S. Provisional Patent Application Ser. No. 63/110,640, filed on Nov. 6, 2020, the entire disclosure of which is hereby incorporated herein by reference in its entirety for all purposes.

### BACKGROUND

### Field of Invention

The present invention relates to an improved ingredient for animal feed that is produced using a tribo-electrostatic separation process from dried distillers grains/dried distillers grain with solubles (DDG/DDGS), which is a co-product of ethanol production.

### Background of the Invention

Many ingredients used in human food and animal feed materials consist of dry mixtures of mostly proteins, starches, sugars, fibers, fats and lipids. The naturally occurring crops are harvested, cleaned, dried, tempered, milled, and purified as required for their ultimate usage as ingredients in human food and animal feed products. The purification process typically consists of dry physical separation based on particle size, or wet processes that use additional chemicals, alkaline water, acidic water, or other solvents to purify the component of interest to generate the high value food or feed ingredient, and generate by-products that are used as lower value ingredients.

A major category of feed ingredients are distiller's grains, which are the by-product of the ethanol fermentation and distillation process. Distiller's grains refer to the solid residue produced as a by-product of distillation processes. Distillers grains are produced using corn, rice, or other grains. Distiller's grains can be dried to increase shelf life and allow the by-product to be transported over long distances for use as an animal feed material. Often the dried distiller's grains (DDG) are mixed with condensed distiller's solubles prior to drying. In this case the dried material is referred to as dried distiller's grains with solubles (DDGS). The production of corn-based DDGS has increased tremendously since the 1990s with the growth of fuel ethanol production.

Distillers grains have historically been used in the U.S. as a feed for cattle due to its relatively low protein content, and relatively high fiber content. Ethanol producers typically market the distillers grains either wet to local beef cattle ranchers and processors, or dry the material to improve the shelf-life and allow transport to more distant users. The value of corn derived distillers grain is limited due to its low protein content and high fiber content, which limits its usefulness as an animal feed ingredient for mono-gastric animals, such as pigs, poultry, shrimp, and fish. Researcher have investigated various processing schemes to upgrade the protein level of distillers grains by removing fiber and/or oil. High protein DDGS is particularly attractive for the feed industry as a value added ingredient.

Animal feed producers are interested in improved low-cost feed ingredients containing balanced nutritional profile required for growth such as, higher quantity and quality protein, improved bioavailability such as higher true metabolizable energy content, improved digestibility, etc. Also, there is a growing trend in the public to favor food and feed ingredients that are minimally processed and free of solvents or the addition of synthetic chemicals. Cost effective alternative for conventional animal-based protein source has become more popular choices focusing on plant-base protein derived from nutritionally balanced crops.

Aquaculture has become one of the fastest growing segments in the global food production in the last few decades. Accelerated population growth linked to the rising popularity of diverse diet choices including vegetarian and pescatarian diets increased the need for sustainable aquaculture practices in order to meet the demand both economically and ethically. That is why alternative protein sources derived from plant-based ingredients partially or fully replacing animal source protein such as fishmeal and animal-byproduct meal as a primary protein source is attracting the feed formulators. Plant based proteins including soy protein, wheat gluten and sunflower and corn protein can provide equivalent nutritional values at a lower cost. Furthermore, plant protein produced as by-products in the fermentation and pharmaceutical industries are more logical and attractive option in order to avoid a competition with the food industry.

Corn derived distiller grains processed by conventional methods may contain about 25% to about 35% protein on a dry matter basis (% DM). U.S. Pat. No. 8,227,015 B2 and U.S. Pat. No. 9,523,062 disclose a process to extract minor amounts of residual oils from the distillers grain to raise the protein to a maximum of about 35% DM. U.S. Pat. No. 9,113,645 discloses a distillers grain product resulting from the above process with protein level up to 35%, but with low fat content due to the oil removal process.

U.S. Pat. Nos. 8,77,8433; 10,233,404; and 10,519,398 disclose a complicated wet process modification to the conventional alcohol production process where the whole stillage slurry after alcohol distillation is filtered, centrifuged, washed, dewatered, and dried. This wet process requires significant modification to the “back end” of the ethanol production process and complicates operation of the main process. The residual oil present in the distillers is removed with the water soluble solids stream in washing process step resulting in a high-protein low-fat meal product with greater than 40-50% DM protein.

Both of these wet processes are effective at increasing the protein level and decreasing the fat level of the final meal product. Quality and quantity of protein and fat are the major factors that determine the value of a feed ingredient. In addition, high energy content, highly digestible phosphorus of DDGS are ideal properties commonly for monogastric animals especially poultry, aquatic animals and canines. Both of these processes are complicated, require integration into the alcohol production process, and require final product drying for transport of the final meal products. For these reasons, a dry purification process is preferred.

Historically, dry purification for food and feed ingredients consists of size and density based separation processes such as screening, or air classification. These separation processes are limited to applicability only for materials where there is a significant difference in particle size between the components of interest. For example, size based separation methods are not useful in the separation of wheat gluten from wheat starch where the particle size for both components are similar.

Electrostatic separation processes offer a new approach to purification for dry food and feed ingredients where particle size and density based separations are not effective. Electrostatic separation has been applied on the industrial-scale for the past 50 years for the beneficiation of minerals and the recycling of waste materials.

Electrostatic beneficiation allows for separations based on differences in surface chemistry (work function), electrical conductivity, or dielectric properties. Electrostatic separation systems operate on similar principles. All electrostatic separation systems contain a system to electrically charge the particles, an externally generated electric field for the separation to occur in, and a method of conveying particles into and out the separation device. Electrical charging can occur by one or multiple methods including conductive induction, tribo-charging (contact electrification) and ion or corona charging. Electrostatic separation systems utilize at least one of these charging mechanisms.

The tribo-electric belt separator (TBS) has been developed by commonly-owned Assignee of this application. FIG. 1 shows a tribo-electric belt separator system 10 such as is disclosed in commonly-owned U.S. Pat. Nos. 4,839,032 and 4,874,507, which are hereby incorporated by reference in their entirety. Tribo-electric belt separators (TBS) are used to separate the constituents of particle mixtures in the minerals and recycling industries. One embodiment of belt separator system 10 includes parallel spaced electrodes 12 and 14/16 arranged in a longitudinal direction to define a longitudinal centerline 18, and a belt 20 traveling in the longitudinal direction between the spaced electrodes, parallel to the longitudinal centerline. The belt 20 forms a continuous loop which is driven by a pair of end rollers 22, 24. A particle mixture is loaded onto the belt 20 at a feed area 26 between electrodes 14 and 16. Belt 20 includes counter-current traveling belt segments 28 and 30 moving in opposite directions for transporting the constituents of the particle mixture along the lengths of the electrodes 12 and 14/16. The only moving part of the TBS is the belt 20. The belt is therefore a critical component of the TBS. The belt 20 moves at a high speed, for example, up to about 20 m/s. The two belt segments 28, 30 move in opposite directions, parallel to centerline 18, and thus if they come into contact, the relative velocity is about 40 m/s.

A process utilizing the TBS for processing distillers grains has been developed by commonly owned Assignee of this application and is disclosed in commonly owned International Patent Application Serial Nos. PCT/US2018/048241 and PCT/US2020/032098.

### SUMMARY

In accordance with one or more aspects, an improved feed ingredient resulting from the process for fractionating a feed mixture derived from dried distiller's grains (DDG) or distiller's dried grains and mixed with solubles (DDGS) using a tribo-electrostatic separation process is disclosed. The process may be a multi-step or a single-step process. The method may comprise milling the DDG or DDGS feed mixture to a specified particle size, supplying said milled DDG or DDGS feed mixture to a tribo-electrostatic separator, and simultaneously charging and separating said DDG or DDGS feed mixture into at least two subfractions, with one of the subfractions having a true metabolizable energy level (TMEₙ) and protein level higher than the DDG or DDGS feed mixture and higher than that could be obtained otherwise. The subfractions have nearly identical fat content. The high protein subfraction is useful as an improved ingredient in feed for monogastric animals resulting in higher animal growth rates than can be achieved with standard diets.

In some aspects, fat content of one of the subfractions is not significantly reduced, i.e. a decrease in fat content of one of the subfractions is less than 2% absolute.

In accordance with one or more aspects, a DDGS subfraction obtainable by the above process is disclosed.

In some aspects, the DDGS subfraction may be characterized in that the protein content is greater than 39%, and the fat content is greater than 6%. A DDGS subfraction obtainable by the process may be characterized by a protein content of greater than 45%, and the fat content of greater than 4%. A DDGS subfraction obtainable by the process may be characterized in that the protein content is greater than 50%, and the fat content is greater than 2%. A DDGS subfraction obtainable by the process may be characterized by a protein content of greater than 50%, and the gross energy content may be greater than 4700 kcal/kg DM. A DDGS subfraction obtainable by process may be characterized by a protein content of greater than 50%, and the true metabolizable energy (TMEₙ) of greater than 3600 kcal/kg DM.

In some aspects, a DDGS subfraction as disclosed may be used for the feeding of animals. A DDGS subfraction as disclosed may be used for the feeding of mono-gastric animals. A DDGS subfraction as disclosed may be used in aquaculture.

In accordance with one or more aspects, a method of enhancing the true metabolizable energy available to an animal subject is disclosed. The method may comprise administering high-protein corn-based distillers dried grains with solubles (DDGS) to the animal, thereby enhancing the growth of the animal subject. The administered DDGS may be characterized by a true metabolizable energy (TMEₙ) of at least about 3600 kcal/kg DM.

In some aspects, the administered DDGS may comprise a fat content of about 3% to about 7% and a protein content of at least about 35%. The protein content may be at least about 40%, at least about 45%, or at least about 50%.

In some aspects, the animal subject is a monogastric animal subject. In other aspects, the subject is aquatic.

In accordance with one or more aspects, a method of enhancing growth of an animal subject is disclosed. The method may comprise feeding the animal subject corn-based DDGS characterized by a true metabolizable energy (TMEₙ) of at least about 3600 kcal/kg DM.

In accordance with one or more aspects, distillers meal is disclosed. The distillers meal may comprise a crude protein content of at least about 35% by weight on a dry matter basis.

In some aspects, the dry matter crude protein content is at least about 39%. The dry matter crude protein content may be at least about 40%, 45%, 48% or 50%.

In some aspects, the fat content may be greater than about 2%. In at least some aspects, the fat content may be greater than about 4%, e.g. greater than about 6%. In some non-limiting aspects, the fat content is no more than about 8%.

In some aspects, the gross energy content of the distillers meal is greater than 5000 kcal/kg DM. The meal may have a true metabolizable energy (TMEₙ) of greater than about 3600 kcal/kg DM, e.g. greater than about 3800 kcal/kg DM, greater than about 4000 kcal/kg DM, greater than about 4500 kcal/kg DM, or greater than about 5000 kcal/kg DM.

In some aspects, the meal may comprise a fiber content of at least about 3%. The fiber content may be at least about 10% in some non-limiting aspects.

In some aspects, the meal may be a feed supplement. The meal may be a supplement to the feed having an inclusion level ranging from about 10% to 30% inclusion level. In some non-limiting aspects, the meal may be present in the feed at an inclusion level ranging from about 10% to 20% inclusion level. In some specific non-limiting aspects, the meal may be present in the feed at an inclusion level of about 15% to 20% inclusion level. The meal may be present at a higher inclusion level as well.

The feed may further comprise one or more of: fish oil, fish meal, L-Lysine, monocalcium phosphate, poultry by-product, vitamin C, other vitamin, wheat gluten meal, corn protein concentrate, soy meal, soy protein concentrate, rapeseed meal and sunflower meal.

In some aspects, the feed is provided for aquaculture. For example, the feed may be fish feed, i.e. trout feed. In other aspects, the feed is provided for a mono-gastric animal. For example, the feed may be provided for beef cattle, dairy cattle, equine, sheep, swine, chickens, ducks, geese, turkey, rabbits, goats, or as pet food for companion animals.

In some aspects, the meal may be produced via fractionation of a feed mixture derived from dried distiller's grains (DDG) or distiller's dried grains and mixed with solubles (DDGS) using a tribo-electrostatic separation (TBS) process. The DDG or DDGS is corn-based in some non-limiting aspects. The tribo-electrostatic separation process may be a single-step process or a multi-step process.

In some aspects, the fractionation process may comprise: milling the DDG or DDGS feed mixture to a specified particle size, supplying said milled DDG or DDGS feed mixture to a tribo-electrostatic separator, and simultaneously charging and separating said DDG or DDGS feed mixture into at least two subfractions, with one of the subfractions having a protein content and/or a true metabolizable energy level (TMEₙ) higher than the DDG or DDGS feed mixture and higher than that could be obtained otherwise.

In some aspects, the method may further comprise optionally drying the milled DDG or DDGS feed mixture to a specified moisture level depending on the specified particle size. The milled DDG or DDGS feed mixture may be dried if the specified median particle size is at least about, e.g. 225-250 micron or greater.

In some aspects, the DDG or DDGS feed mixture may be characterized by a protein level of between about 30-45%, an oil content of less than about 20%, and/or a moisture content of less than about 30%. The protein level of the DDG or DDGS feed mixture may be in a range of from about 30% to about 35%. The protein level of one of the sub-fractions may be enriched to be anywhere in a range of from about 35% to about 55%, e.g. from about 40% to about 55%. The protein level of one of the subfractions may be enriched by at least an absolute protein increase of about 5%, e.g. an absolute protein increase of from about 10% to about 25%. In at least some aspects, the protein level of a subfraction may be enriched as described herein without significantly reducing fat content.

The specified particle size may be associated with a fine (e.g. about 50-75 micron or less), medium (e.g. about 100-125 micron) or coarse (e.g. about 225-250 micron or greater) particle size.

In some aspects, the feed moisture content may be from about 0% to about 12%. The feed oil content may be from about 0.7% to about 12.0%. The fat content of one of the subfractions may not be significantly reduced, i.e. wherein a decrease in fat content of one of the subfractions is less than 2% absolute. In some aspects, the protein content of one of the subfractions may be enriched by at least about 40% protein (DM).

In some aspects, the feed mixture may be processed at a rate of about 40 to about 17,000 kg per hour per meter of TBS electrode width. A belt speed of the tribo-electrostatic separation process may be from about 10 to about 70 feet per second. An electric field strength of the tribo-electrostatic separation process may be from about 120 to about 4,000 kV/m.

In some aspects, the DDG or DDGS feed mixture is milled to a specified median particle size of about 225-250 micron or greater and then dried in order to achieve an absolute protein increase of at least about 10%. The milled DDG or DDGS feed mixture is dried in order to achieve a moisture content of about 6.4% or less.

In some aspects, the DDG or DDGS feed mixture is milled to a specified median particle size of less than 125 microns. The feed mixture moisture content is less than about 5.8%.

In some aspects, the milled DDG or DDGS feed mixture need not be dried in order to achieve an absolute protein increase of at least about 10%.

In some aspects, the DDG or DDGS feed mixture is milled to a specified median particle size of about 50-75 micron or less.

In some aspects, the milled DDG or DDGS feed mixture need not be dried in order to achieve an absolute protein increase of at least about 10%.

In accordance with one or more aspects, a DDGS subfraction of a tribo-electric separation process may be characterized in that the protein content is greater than 39%, and the fat content is greater than 6%.

In accordance with one or more aspects, a DDGS subfraction of a tribo-electric separation process may be characterized in that the protein content is greater than 45%, and the fat content is greater than 4%.

In accordance with one or more aspects, a DDGS subfraction of a tribo-electric separation process may be characterized in that the protein content is greater than 50%, and the fat content is greater than 2%.

In accordance with one or more aspects, a DDGS subfraction of a tribo-electric separation process may be characterized in that the protein content is greater than 50%, and the gross energy content is greater than 5000 kcal/kg DM.

In accordance with one or more aspects, a DDGS subfraction of a tribo-electric separation process may be characterized in that the protein content is greater than 50%, and the true metabolizable energy (TMEₙ) is greater than 3600 kcal/kg DM.

In accordance with one or more aspects, any DDGS subfraction may be used for the feeding of animals. For example, a DDGS subfraction may be used for the feeding of mono-gastric animals.

In accordance with one or more aspects, any DDGS subfraction may be used for aquaculture feeding. For example, a DDGS subfraction may be used for feeding fish, e.g. trout.

In accordance with one or more aspects, a method of enhancing the true metabolizable energy available to an animal subject is disclosed. The method may comprise administering high-protein corn-based distillers dried grains with solubles (DDGS) to the animal, thereby enhancing the growth of the animal subject, wherein the administered DDGS is characterized by a true metabolizable energy (TMEₙ) of at least about 3600 kcal/kg DM.

In some aspects, the administered DDGS comprises a fat content of about 3% to about 7% and a protein content of at least about 35%.

In some aspects, the protein content may be at least about 40%, e.g. at least about 45% or at least about 50%

In some aspects, the animal subject is a monogastric animal subject.

In accordance with one or more aspects, a method of enhancing growth of an animal subject is disclosed. The method may comprise feeding the animal subject corn-based DDGS characterized by a true metabolizable energy (TMEₙ) of at least about 3600 kcal/kg DM.

The corn-based DDGS may have a fat content of about 3% to about 7% and a protein content of at least about 35%.

In some aspects, the protein content may be at least about 40%, e.g. at least about 45% or at least about 50%.

In some aspects, the animal subject is a monogastric animal subject.

In some aspects, the corn-based DDGS may be characterized by a true metabolizable energy (TMEₙ) of at least about 3800 kcal/kg DM, at least about 4500 kcal/kg DM, or at least about 5000 kcal/kg DM.

In accordance with one or more aspects, a method of enhancing growth of a marine subject is disclosed. The method may comprise feeding the subject fish feed including corn-based DDGS characterized by protein content of at least 35% by weight on a dry matter basis.

In some aspects, the protein content may be at least about 40%, e.g. at least about 45%, at least about 48% or at least about 50%.

In some aspects, the subject may be a trout.

In accordance with one or more aspects, an animal feed product is disclosed. The feed product may comprise a corn-based DDGS having a true metabolizable energy (TMEₙ) of at least about 3500 kcal/kg DM.

In some aspects, the true metabolizable energy (TMEₙ) may be at least about 3800, 4000, 4500 or 5000 kcal/kg DM.

In some aspects, the corn-based DDGS has a gross energy content of greater than about 4000 kcal/kg DM.

In some aspects, the animal feed product may comprise a fat content of about 3% to about 7% and a protein content of at least about 35%. In some non-limiting aspects, the protein content may be at least about 40%, at least about 45%, or at least about 50%.

In accordance with one or more aspects, an aquaculture feed product is disclosed. The feed product may comprise a corn-based DDGS having a protein content of at least about 35%.

In some non-limiting aspects, the protein content may be at least about 40%, at least about 45%, or at least about 50%.

In some aspects, the product may have a fat content of about 3% to about 7%.

In some aspects, the true metabolizable energy (TMEₙ) may be at least about 3600, 3800, 4000, 4500 or 5000 kcal/kg DM.

In some aspects, the corn-based DDGS has a gross energy content of greater than about 4000 kcal/kg DM.

In some aspects, any of the disclosed feed products may further comprise one or more of: fish oil, fish meal, L-Lysine, monocalcium phosphate, poultry by-product, vitamin C, other vitamin, wheat gluten meal, corn protein concentrate, soy meal, soy protein concentrate, rapeseed meal and sunflower meal.

### BRIEF DESCRIPTION OF DRAWINGS

Certain illustrative features and examples are described below with reference to the accompanying figures in which:

FIG. 1 is a schematic of a prior art tribo-electric belt separator system.

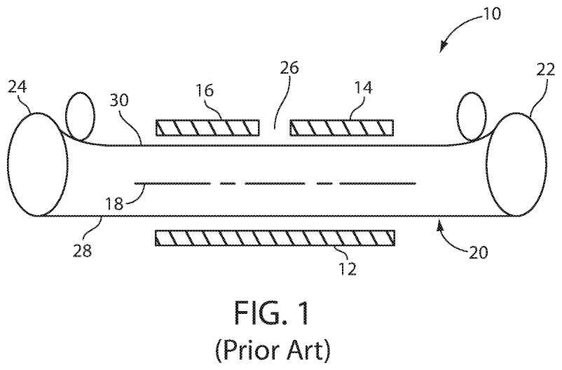

The advantages of the aspect and embodiments of this disclosure may be better understood by referring to the following description when taken in conjunction with the drawings. The drawings are not intended to be drawn to scale. In the drawings, each identical or nearly identical component that is illustrated in various figures is represented by a like numeral. For purposes of clarity, not every component may be labeled in every drawing. It will be recognized by the person of ordinary skill in the art, given the benefit of this disclosure, that the dimensions, sizes, components, and views shown in the figures are for illustrative purposes. Other dimensions, representations, features, and components may also be included in the embodiments disclosed herein without departing from the scope of the description.

### DETAILED DESCRIPTION

The disclosure is not limited in its application to the details of construction and the arrangement of components set forth in the following description or illustrated in the drawings. Aspects of the disclosure are capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items. At least one aspect of the present disclosure is directed to the improved animal feed ingredient produced using a tribo-electric enrichment process and system for the enrichment of protein and true metabolizable energy content from low value by-products such as, for example, those resulting from distillation industries i.e. dried distiller's grains with or without solubles (DDGS or DDG) and to the resulting products from the process, particularly the product that is enriched in protein. The enriched products can have increased value as an ingredient in animal feed formulations.

In particular, at least one embodiment of the process includes supplying a DDGS/DDG feed mixture to a tribo-electric separator and charging and separating the feed mixture into at least two sub-fractions, with one of the subfractions enriched in protein and true metabolizable energy and having a composition different than the feed mixture. In at least one embodiment, the protein concentration of one of the products of the separator apparatus and process is higher than would otherwise be achievable with the prior art processes or that is naturally occurring.

Examples of separation results obtained from dried distillers grains are detailed below.

### Example 1: Enrichment of Protein from DDGS

A sample of corn-based distillers dried grains with solubles (DDGS) was prepared for testing using the TBS apparatus and process to demonstrate the capability of the TBS apparatus and process to simultaneously charge and separate distinct protein and starch particles using the TBS apparatus and process in a single step. Feed sample was prepared at three different particle sizes using an impact-type mill—coarse grind with a median (D50) particle size: 225-250 micron, medium grind (D50) with a median particle size: 100-125 micron, and fine grind with a median (D50) particle size: 50-75 micron. The results are described below:

### Medium Grind:

The sample was milled using an impact-type mill to a median particle size of approximately 100-125 micron, contained approx. 8% moisture after milling. The feed sample was fed as-received, with no adjustment to the moisture content, into the TBS separator at a rate of 17 tonne per hour per meter of TBS electrode width. The TBS belt speed was set at 15 feet per second, and 12 kV was applied across the TBS electrode gap to produce an electric field strength of 1390 kV/m. Two resulting products were collected from the two ends of the separator. There was no middling fraction that needed to be re-processed. Table 1 shows the mass yields of the two products, the composition of the feed and the products, achieved in a first pass. For purposes of this example, first pass refers to the feed material having been processed through the separator once.

TABLE 1
Results from testing corn-based DDGS (medium grind, first pass)

| | | Product 1 | Product 2 |
|---|---|---|---|
| | | (Enriched | (Enriched |
| | Feed | Fiber) | Protein) |
| Mass | 100% | 71% | 29% |
| Protein (dry basis) | 34.8% | 30.0% | 46.8% |
| Moisture | 7.9% | — | — |
| Crude Fiber | 6.9% | 9.0% | 3.8% |
| Fiber (ADF) | 11.3% | 11.8% | 11.0% |
| Fiber (NDF) | 26.6% | 34.8% | 14.0% |
| Oil | 7.2% | 7.1% | 7.6% |
| Protein Recovery | | 51% | 49% |

The high-protein product from the first pass was then processed through the separator again (second pass) and further protein increase was achieved. The results are shown in Table 2.

TABLE 2
Results from testing corn-based
DDGS (medium grind, second pass)

| | | Product 1 | Product 2 |
|---|---|---|---|
| | | (Enriched | (Enriched |
| | Feed | Fiber) | Protein) |
| Mass | 100% | 55% | 45% |
| Protein (dry basis) | 46.8% | 42.7% | 51.8% |
| Moisture | 7.9% | — | — |
| Fiber (ADF) | | 11.1% | 8.9% |
| Fiber (NDF) | | 19.3% | 13.0% |
| Oil | | 7.7% | 7.8% |
| Protein Recovery | | 50.3% | 49.7% |

The effect of moisture on medium grind feed by drying was tested, and no significant effect on protein separation was found.

### Fine Grind:

The sample was milled using an impact-type mill to a median particle size of approximately 50-75 micron, contained approx. 6% moisture after milling. The feed sample was fed as-received, with no adjustment to the moisture content, into the TBS separator at a rate of 17 tonne per hour per meter of TBS electrode width. The TBS belt speed was set at 15 feet per second, and 12 kV was applied across the TBS electrode gap to produce an electric field strength of 1390 kV/m. Table 3 shows the mass yields of the two products, the protein content of the feed and the products.

TABLE 3
Results from testing corn-based DDGS (fine grind)

| | | Product 1 | Product 2 |
|---|---|---|---|
| | | (Enriched | (Enriched |
| | Feed | Fiber) | Protein) |
| Mass | 100% | 70% | 30% |
| Protein (dry basis) | 33.9% | 28.8% | 45.9% |
| Moisture | 5.8% | — | — |

### Coarse Grind:

The sample was milled using an impact-type mill to a median particle size of approximately 225-250 micron, contained approx. 10% moisture after milling. The feed sample was fed as-received, with no adjustment to the moisture content, into the TBS separator at a rate of 17 tonne per hour per meter of TBS electrode width. The TBS belt speed was set at 65 feet per second, and 12 kV was applied across the TBS electrode gap to produce an electric field strength of 1390 kV/m. Table 4 shows the mass yields of the two products, the protein content of the feed and the products.

TABLE 4
Results from testing corn-based DDGS (coarse grind)

| | | Product 1 | Product 2 |
|---|---|---|---|
| | | (Enriched | (Enriched |
| | Feed | Fiber) | Protein) |
| Mass | 100% | 84% | 16% |
| Protein (dry basis) | 34.1% | 33.5% | 39.0% |
| Moisture | 10.3% | — | — |

Effect of moisture was investigated on coarse grind feed by drying. Table 5 shows the mass yields of the two products, and protein content of the feed and the products upon reduction of moisture content. In comparison to Table 4, results showed that the protein separation improved significantly at similar mass yields compared to the un-dried feed for coarse grind feed.

TABLE 5
Results from testing corn-based DDGS (coarse grind, dried)

| | | Product 1 | Product 2 |
|---|---|---|---|
| | | (Enriched | (Enriched |
| | Feed | Fiber) | Protein) |
| Mass | 100% | 85.1% | 14.9% |
| Protein (dry basis) | 34.1% | 32.5% | 44.1% |
| Moisture | 6.4% | — | — |

It was demonstrated that in order to achieve substantial protein increase (≥10% absolute) the feed material must be milled to a particle size with median (D50): 100-125 micron, or milled to finer particle size with median (D50): 50-75 micron, or milled to coarse particle size with median (D50): 225-250 micron and then dried, for example, to 6.4%. It is reasonable to conclude that drying is also useful for particle sizes of greater than 225-250 micron. For example, coarse milled feed material may need to be dried in order to achieve at least about a 10% absolute increase in protein content. Drying does not appear to be required for particle sizes of 100-125 micron or finer. In at least some embodiments, DDG or DDGS with a particle size equal to or less than about median (D50): 100-125 micron need not be dried in order to still achieve at least about a 10% absolute increase in protein content.

This example demonstrates the capability of TBS process to effectively tribo-charge and separate distinct protein and fiber particles in a single step from a DDGS feed sample in fine dry powder form, generating product streams enriched in each component.

Feed ingredient performance for mono-gastric and aquatic animals for the enhanced sub-fraction obtained using the TBS process are detailed in the following examples.

### EXAMPLE 2

### Energy Content in High Protein DDGS Fractions Obtained by Rooster Assays

Reflecting the rapid growth of the fuel ethanol industry in the early 2000s, corn-based DDGS has found an application in animal feed especially for monogastric animal such as poultry and swine. In such feed formulation, energy, digestible amino acid and phosphorus values are the determining factors of its quality, most of which are available in DDGS. Not only is corn-based DDGS nutritionally ideal for poultry feed but also its low price and availability offer an economical advantage. Furthermore, technological advancement in the fuel ethanol industry enabled to partially remove oil throughout the process resulting in low-fat DDGS. The low-fat DDGS contains 3%-7% fat as compared to the traditional DDGS which contains up to 10% fat. Other example of processing innovation is the production of high protein DDGS which contains significantly higher protein content of 50% compared to the conventional DDGS at around 35% protein. DDGS with various fat contents and its effects on feed quality has been researched extensively yet few research high protein corn-based DDGS.

A rooster assay utilizing cecectomized roosters was conducted to determine true metabolizable energy (TMEₙ) using a fine-ground, corn-based high protein DDGS processed by the triboelectric belt separator (TBS). TMEₙ is defined as its gross energy minus the energy in feces and urine derived from the same quantity of that diet (Equation A). A testing procedure approved by the Institutional Animal Care and Use committee was followed to determine the TMEₙ: After 24 hours of feed withdrawal 5 cecectomized adult Comb White Leghorn roosters were tube-fed approximately 30g of high protein DDGS. Another 5 roosters were fasted for additional 48 hours. Excreta from each bird were then collected for 48 hours and analyzed for gross energy using an adiabatic oxygen bomb calorimeter standardized with benzoic acid and then TMEₙ was calculated as equation shown below (Equation A):

$$TMEn = \frac{FEf - ( EEf + 8.22 N f ) + ( EEu + 8.22 N u )}{FC}$$

where FE_{f} equals the gross energy of the total feed consumed; EE_{f} and EEᵤ equals the energy in the excreta collected from the fed birds and fasted birds, respectively; N_{f} and Nᵤ equals the gram nitrogen retained by the fed birds and fasted birds, respectively; and FC equals the grams of dry feed consumed (Parsons et al. 1982).

Dry matter, crude protein, crude fat, gross energy, and TMEₙ values of the high protein DDGS processed with TBS (TBS 50% protein DDGS or TBS DDGS) along with conventional DDGS and commercially available 50% protein corn meal product produced using the process described in U.S. Pat. Nos. 10,233,404 and 10,519,398 (high protein Corn Meal Product) are shown in the Table 6. Compared to the conventional milled DDGS where the crude fat content is similar to the TBS 50% protein DDGS, the TBS DDGS has shown 916 kcal/Kg DM (or 24%) increase in TMEₙ value. The crude protein of the TBS DDGS was 18.2% DM higher than the conventional milled DDGS. Comparing to the existing high protein Corn Meal Product to TBS DDGS, TBS DDGS contained 0.9% DM lower crude protein, 5.8% DM higher crude fat and 725 kcal/Kg DM (or 19%) higher TMEₙ value.

The in vivo rooster assay demonstrated the additional benefit of TBS process minimizing a fat reduction while enriching protein resulting in a unique high protein DDGS with fat content equivalent to the conventional DDGS. The TBS DDGS showed a drastic increase in true metabolizable energy compared to both conventional DDGS and High Protein Corn Meal Product providing additional value as a feed ingredient.

TABLE 6
Dry matter, crude protein, crude fat and true metabolizable
energy comparison of conventional DDGS, TBS high
protein DDGS, TBS low protein DDGS and commercially
available High protein Corn Meal Product.

| | | | | Gross | |
|---|---|---|---|---|---|
| | Dry | Crude | Crude | Energy | TMEₙ |
| | Matter | protein | fat | Kcal/g | (kcal/Kg |
| Sample | (%) | (% DM) | (% DM) | DM | DM) |
| Conventional DDGS | 89.4 | 33.5 | 8.9 | 4594 | 2909 |
| feed (no milling) | | | | | |
| Conventional DDGS | 93.7 | 33.3 | 8.9 | 4591 | 2941 |
| milled feed | | | | | |
| TBS DDGS high | 92.5 | 51.5 | 7.8 | 5416 | 3857 |
| protein sample 1 | | | | | |
| TBS DDGS high | 92.8 | 43.7 | NA | 4744 | 3663 |
| protein sample 2 | | | | | |
| TBS DDGS low | 93.6 | 28.9 | NA | 4543 | 2879 |
| protein sample 2 | | | | | |
| High protein corn meal | 93.7 | 52.4 | 2.0 | NA | 3132 |
| product¹ | | | | | |

¹Source: Specification of product presented in U.S. Pat. No. 8778433

### EXAMPLE 3

### Approximate Growth Performance in Fish Diet Formulated with TBS High Protein DDGS Obtained by Trout Digestibility Trial

A 35 day trout feeding trial with experimental fish diet formulated with TBS high protein (HP)-DDGS was conducted to determine the effect of TBS HP-DDGS in feed digestibility, growth performance and feed intake. TBS HP-DDGS at 48% (DM) protein content was used (Table 7). Female rainbow trout were fed with formulated fish diets containing TBS HP-DDGS at 0, 10, 20 and 30% inclusion levels (Table 8). Diets were formulated to meet nutritional requirement of rainbow trout at given HP-DDGS inclusion levels (NRC, 2011). Trout that have been fed with commercial diet were put into an acclimation period over a week prior to the trial. Commercial diet was transitioned into experimental diet every two days in the ratio of 25:75, 50:50, 75:50, and 100:0. Each diet was tested in three circular digestibility tanks in which data including water condition, growth performance and fecal matter were collected for 35 days. Feed conversion ratio (FCR) was calculated as the weight of feed divided by biomass gain achieved in the same tank during the same period.

TABLE 7
Composition of TBS HP-DDGS used for feed formulation

| Composition | Unit | HP-DDGS |
|---|---|---|
| Dry Matter | % | 95.5 |
| Crude Protein | % DM | 47.7 |
| Crude Fat | % DM | 8.1 |
| Crude Fiber | % DM | 3.1 |
| Ash | % DM | 5.5 |
| Neutral Detergent Fiber (NDF) | % DM | 26.7 |
| Acid Detergent Fiber (ADF) | % DM | 23.4 |

TABLE 8
Feed formulation of the four experimental diets with
graded inclusion of HP-DDGS fed to rainbow trout

| | Inclusion (% as-fed) | | | |
|---|---|---|---|---|
| | A | B | C | D |
| Ingredients | (Reference) | (10HP) | (20HP) | (30HP) |
| Corn protein concentrate | 10.00 | 9.00 | 8.00 | 7.00 |
| Fish oil herring | 10.74 | 9.67 | 8.59 | 7.52 |
| Fish meal herring | 30.00 | 27.00 | 24.00 | 21.00 |
| L-Lysine | 0.03 | 0.03 | 0.03 | 0.02 |
| Monocalcium Phosphate | 3.43 | 3.08 | 2.74 | 2.40 |
| (21% P) | | | | |
| Poultry by-product meal | 20.00 | 18.00 | 16.00 | 14.00 |
| Low ash | | | | |
| Stabilized vitamin in c | 0.30 | 0.27 | 0.24 | 0.21 |
| (Stay-C) | | | | |
| Vitamin & mineral premix | 0.50 | 0.45 | 0.40 | 0.35 |
| Wheat gluten meal | 10.00 | 9.00 | 8.00 | 7.00 |
| Wheat flour | 14.50 | 13.00 | 11.50 | 10.00 |
| TBS HP-DDGS (HP) | 0.00 | 10.00 | 20.00 | 30.00 |
| Titanium dioxide | 0.50 | 0.50 | 0.50 | 0.50 |
| Total | 100 | 100 | 100 | 100 |

Preliminary data including initial body weight (IBW), final body weight (FBW), weigh gain (WG), growth rate measured as thermal-unit growth coefficient (TGC), feed intake (FI), and feed conversion ratio (FCR) obtained from 35 days of feeding period are shown in Table 9. The experimental diet with TBS HP-DDGS showed positive effects on growth performance and feed efficiency within the length of trial. Diet with 30% TBS HP-DDGS inclusion showed 21% higher weight gain compared to the reference diet. Feed intake of diet with 30% inclusion showed 29% higher feed intake compared to the reference diet. These results imply that there is a correlation between palatability and growth performance. Little difference between 20% and 30% TBS HP-DDGS inclusion levels was observed.

The approximate growth rate and feed intake results relative to TBS HP-DDGS inclusion levels strongly indicates the potential of TBS HP-DDGS as a value-added ingredient for aquafeed.

TABLE 9
Initial body weight (IBW), final body weight (FBW), weight gain (WG), growth rate
measured as thermal-unit growth coefficient (TGC), feed intake (FI), and feed conversion
ratio (FCR) of Rainbow trout fed the experimental diets containing different High Protein
Distillers Dried Grains with Solubles (HP-DDGS)

| | IBW | FBW | WG | TGC | FI | |
|---|---|---|---|---|---|---|
| Diet | (g fish⁻¹) | (g fish⁻¹) | (g fish⁻¹) | [g^{1/3} (° C. · d⁻¹)] | (g fish⁻¹) | FCR |
| Day 0-35 | | | | | | |
| A (0% HP-DDGS) | 35.23 (0.50) | 73.86 (0.37) | 38.62 (0.28) | 0.182 (0.002) | 40.06 (0.46) | 1.04 (0.02) |
| B (10% HP-DDGS) | 34.79 (0.15) | 75.08 (0.43) | 40.29 (0.34) | 0.190 (0.001) | 46.22 (0.19) | 1.15 (0.01) |
| C (20% HP-DDGS) | 34.82 (0.42) | 78.73 (2.56) | 43.91 (2.18) | 0.203 (0.007) | 47.20 (2.16) | 1.08 (0.02) |
| D (30% HP-DDGS) | 34.53 (0.26) | 81.16 (1.31) | 46.62 (1.23) | 0.213 (0.004) | 51.75 (0.82) | 1.11 (0.02) |

Average values with Standard Deviation in parenthesis

What is claimed is:

1. An animal feed ingredient comprising dried distillers grains comprising a crude protein content of at least about 39% by weight on a dry matter basis and a fat content greater than 5% and having a true metabolizable energy (TMEₙ) greater than about 3600 kcal/kg DM.

2.-3. (canceled)

4. The animal feed ingredient of claim 1, wherein the dry matter crude protein content is at least about 40%.

5. The animal feed ingredient of claim 1, wherein the dry matter crude protein content is at least about 45%.

6. The animal feed ingredient of claim 5, wherein the fat content is greater than 4%.

7. The animal feed ingredient of claim 1, wherein the dry matter crude protein content is at least about 48%.

8. The animal feed ingredient of claim 1, wherein the dry matter crude protein content is at least about 50%.

9. The animal feed ingredient of claim 8, wherein the fat content is greater than 2%.

10. The animal feed ingredient of claim 1, wherein the gross energy content is greater than 5000 kcal/kg DM.

11. (canceled)

12. The animal feed ingredient claim 1, having a true metabolizable energy (TMEₙ) of greater than about 3800 kcal/kg DM.

13. The animal feed ingredient claim 1, having a true metabolizable energy (TMEₙ) of greater than about 4000 kcal/kg DM.

14. The animal feed ingredient claim 1, having a true metabolizable energy (TMEₙ) of greater than about 4500 kcal/kg DM.

15. The animal feed ingredient of claim 1, further comprising a fiber content of at least about 3%.

16. The animal feed ingredient of claim 1, further comprising a fiber content of at least about 10%.

17. The animal feed ingredient of claim 1, further comprising a fat content of no more than about 8%.

18. The animal feed ingredient of claim 1, wherein the meal is a feed supplement.

19. The animal feed ingredient of claim 18, wherein the meal is a supplement to the feed having an inclusion level ranging from about 10% to 30% inclusion level.

20. The animal feed ingredient of claim 19, wherein the meal is a supplement to the feed having an inclusion level ranging from about 10% to 20% inclusion level.

21. The animal feed ingredient of claim 19, wherein the meal is a supplement to the feed having an inclusion level ranging of about 20% inclusion level.

22. The animal feed ingredient of claim 18, wherein the feed further comprises one or more of: fish oil, fish meal, L-Lysine, monocalcium phosphate, poultry by- product, vitamin C, other vitamin, wheat gluten meal, corn protein concentrate, soy meal, soy protein concentrate, rapeseed meal and sunflower meal.

23. The animal feed ingredient of claim 18, wherein the feed is provided for aquaculture.

24. The animal feed ingredient of claim 18, wherein the feed is fish feed, i.e. trout feed.

25. The animal feed ingredient of claim 18, wherein the feed is provided for a mono-gastric animal.

26. The animal feed ingredient of claim 25, wherein the feed is provided for beef cattle, dairy cattle, equine, sheep, swine, chickens, ducks, geese, turkey, rabbits, goats, or as pet food for companion animals.

27. The animal feed ingredient of claim 1, produced via fractionation of a feed mixture derived from dried distiller's grains (DDG) or distiller's dried grains and mixed with solubles (DDGS) using a tribo-electrostatic separation (TBS) process.

28. The animal feed ingredient of claim 27, wherein the DDG or DDGS is corn-based.

29. The animal feed ingredient of claim 27, wherein the tribo-electrostatic separation process is a single-step process.

30. The animal feed ingredient 1 of claim 27, wherein the fractionation process comprises:
a. milling the DDG or DDGS feed mixture to a specified particle size;
b. supplying said milled DDG or DDGS feed mixture to a tribo-electrostatic separator; and
c. simultaneously charging and separating said DDG or DDGS feed mixture into at least two subfractions, with one of the subfractions having a protein content and/or a true metabolizable energy level (TMEₙ) higher than the DDG or DDGS feed mixture and higher than that could be obtained otherwise.

31. The animal feed ingredient of claim 30, wherein the method further comprises optionally drying the milled DDG or DDGS feed mixture to a specified moisture level depending on the specified particle size.

32. The animal feed ingredient of claim 30, wherein the milled DDG or DDGS feed mixture is dried if the specified median particle size is at least about, e.g. 100-125 micron or greater.

33. The animal feed ingredient of claim 27, wherein the DDG or DDGS feed mixture is characterized by a protein level of between about 30-45%, an oil content of less than about 20%, and/or a moisture content of less than about 30%.

34. The animal feed ingredient of claim 33, wherein the protein level of the DDG or DDGS feed mixture is in a range of from about 30% to about 35%.

35. The animal feed ingredient of claim 33, wherein the protein level of one of the sub-fractions is enriched to be anywhere in a range of from about 35% to about 55%, e.g. from about 40% to about 55%.

36. The animal feed ingredient of claim 33, wherein the protein level of one of the subfractions is enriched by at least an absolute protein increase of about 5%, e.g. an absolute protein increase of from about 10% to about 25%.

37. The animal feed ingredient of claim 30, wherein the specified particle size is associated with a fine (e.g. about 50-75 micron or less), medium (e.g. about 100-125 micron) or coarse (e.g. about 225-250 micron or greater) particle size.

38. The animal feed ingredient of claim 33, wherein the feed moisture content is from about 0% to about 12%.

39. The animal feed ingredient of claim 33, wherein the feed oil content is from about 0.7% to about 12.0%.

40. The animal feed ingredient of claim 30, wherein fat content of one of the subfractions is not significantly reduced, i.e. wherein a decrease in fat content of one of the subfractions is less than 2% absolute.

41.-44. (canceled)

45. The animal feed ingredient of claim 30, wherein the DDG or DDGS feed mixture is milled to a specified median particle size of about 225-250 micron or greater and then dried in order to achieve an absolute protein increase of at least about 10%.

46. The animal feed ingredient of claim 45, wherein the milled DDG or DDGS feed mixture is dried in order to achieve a moisture content of about 6.4% or less.

47. The animal feed ingredient of claim 30, wherein the DDG or DDGS feed mixture is milled to a specified median particle size of less than 125 microns.

48. The animal feed ingredient of claim 47, wherein the feed mixture moisture content is less than about 5.8%.

49. The animal feed ingredient of claim 47, wherein the milled DDG or DDGS feed mixture need not be dried in order to achieve an absolute protein increase of at least about 10%.

50. The animal feed ingredient of claim 30, wherein the DDG or DDGS feed mixture is milled to a specified median particle size of about 50-75 micron or less.

51. The animal feed ingredient of claim 50, wherein the milled DDG or DDGS feed mixture need not be dried in order to achieve an absolute protein increase of at least about 10%.

52.-98. (canceled)
